(19) United States
(12) Patent Application Publication
(10) Pub. No.: US 2026/0370546 A1
(43) Pub. Date: Nov. 19, 2026

(54) DYNAMIC ANIMATION SOURCE FOR AVATAR CALLS

(71) Applicant: Nokia Technologies Oy, Espoo (FI)

(72) Inventors: Saba AHSAN, Espoo (FI); Serhan GÜL, Munich (DE); Gazi Karam ILLAHI, Espoo (FI); Igor Danilo Diego CURCIO, Vimercate (IT)

(21) Appl. No.: 19/677,343

(22) Filed: May 14, 2026

Related U.S. Application Data
(60) Provisional application No. 63/807,031, filed on May 16, 2025.

(51) Int. Cl. H04L 41/069; G06T 13/20; G06T 13/40; H04L 51/046; H04L 65/1016; H04L 65/1069; H04L 65/1089

(52) U.S. Cl. CPC H04L 41/069; G06T 13/205; G06T 13/40; H04L 51/046; H04L 65/1016; H04L 65/1069; H04L 65/1089

(57) ABSTRACT

An apparatus includes at least one processor, and at least one memory storing instructions that, when executed by the at least one processor, cause the apparatus at least to: establish an avatar call with a user device, establish a data channel for avatar metadata exchange with the user device, send over the data channel a configuration message that indicates an animation fallback comprising a list of uniform resource names indicating supported animation data to be used as a fallback for animating an avatar when a selected animation stream stops, and send over the data channel a stopped message when the selected animation stream becomes temporarily unavailable, the stopped message comprising a type field set to a uniform resource name that identifies the stopped message.

### CROSS REFERENCE TO RELATED APPLICATIONS

This application claims priority to U.S. Provisional Application No. 63/807,031, filed May 16, 2025, which is incorporated by reference herein in its entirety.

### TECHNICAL FIELD

The examples and non-limiting example embodiments relate generally to multimedia transport and, more particularly, to dynamic animation source for avatar calls.

### BACKGROUND

It is known for a communication device to transport media over a communication network.

### SUMMARY

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 shows an avatar reference architecture.

FIG. 3 depicts mapping avatar functions to an internet protocol (IP) multimedia subsystem (IMS) data channel (DC) architecture.

FIG. 4 depicts a network centric call setup and capability negotiation flow.

FIG. 5 depicts a user equipment (UE) centric call setup and capability negotiation flow.

FIG. 6 depicts a real time communication (RTC) architecture for avatar-based communication.

FIG. 7 is an example apparatus configured to implement the examples described herein.

FIG. 8 shows a representation of an example of non-volatile memory media used to store instructions that implement the examples described herein.

FIG. 9 is an example method, based on the examples described herein.

FIG. 10 is an example method, based on the examples described herein.

### DETAILED DESCRIPTION

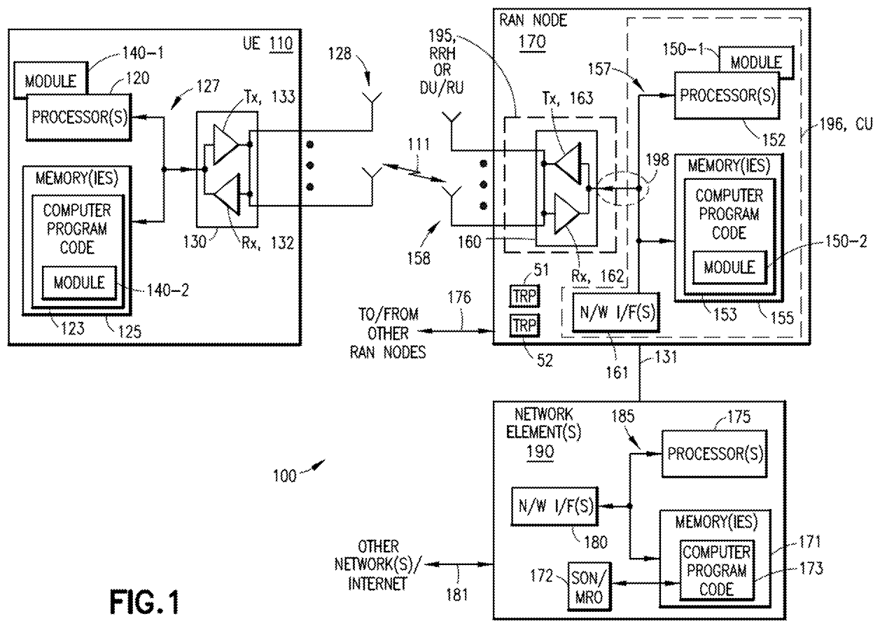

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, (fifth generation) also called New Radio (NR). In 5G, the RAN node 170 may be a new generation (NG) RAN (NG-RAN) node, which is defined as either a next generation node B (gNB, or base station for 5G/NR) or a new generation evolved Node B (ng-eNB). A gNB is a node providing NR user plane and control plane protocol terminations towards the UE, and connected via the NG interface (such as connection 131) to a 5G core network (5GC) (such as, for example, the network element(s) 190). The ng-eNB is a node providing evolved universal mobile telecommunications service (UMTS) terrestrial radio access (E-UTRA) user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), service data adaptation protocol (SDAP) and packet data convergence protocol (PDCP) protocols of the gNB or RRC and PDCP protocols of the en-gNB (node providing NR user plane connectivity to the UE) that control the operation of one or more gNB-DUs. The gNB-CU 196 terminates the F1 interface (interface between a CU and a DU) connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting radio link control (RLC), medium access control (MAC) and physical (PHY) layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved Node B) base station, for LTE (long term evolution), or any other suitable base station or node.

The RAN node 170 includes one or more processors 152, one or more memories 155, one or more network (N/W) interfaces (I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn (network interface between NG RAN nodes) interface for 5G, an X2 (network interface between RAN nodes and between RAN and the core network) interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more transmission reception points (TRPs) to which the methods described herein may be applied. FIG. 1 shows that the RAN node 170 comprises TRP 51 and TRP 52, in addition to the TRP represented by transceiver 160. Similar to transceiver 160, TRP 51 and TRP 52 may each include a transmitter and a receiver. The RAN node 170 may host or comprise other TRPs not shown in FIG. 1.

A relay node in NR is called an integrated access and backhaul (IAB) node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or mobility robustness optimization (MRO) functionality 172.

The wireless network 100 may implement network virtualization, which is the process of combining hardware and software network resources and network functionality into a single, software-based administrative entity, or a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, an unmanned aerial vehicle (UAV) such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

Described herein are examples that relate to an avatar call in a third generation partnership project (3GPP) system. The call can be two-party or multi-party communication with audio, where avatars and audio of each participant are transmitted and spatially rendered in extended reality (XR). The source data for animating the avatar is generated using on-device sensors, e.g., a camera, microphone, accelerometer, gyroscope, etc. The animation data from the source data may be generated on-device or in the network. The animation data is used to animate the avatar on-device, in the network or on the remote device.

3GPP technical report (TR) 22.856 V 19.2.0 investigates use cases and service requirements for 5G System (5GS) support of enhanced XR-based services as part of “Metaverse” services. The use cases include enabling of avatar calls in 3GPP services. 3GPP TR 26.813 further lists use cases for avatar communication, outlines the associated requirements for real-time rendering, encoding, and transmission of avatar data. The document further lists existing formats for avatar and animation representation, and procedures for realizing an avatar call using IMS and non-IMS based services.

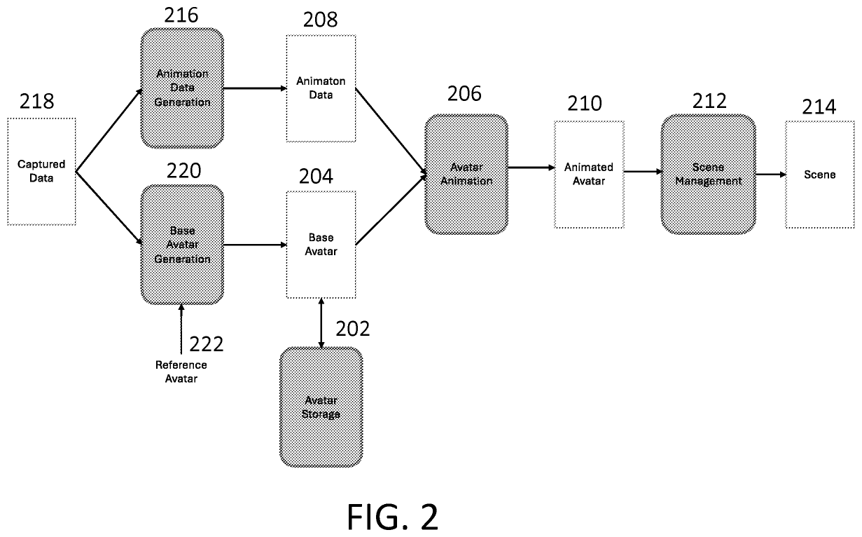

FIG. 2 shows an avatar reference architecture. FIG. 2 consists of the following functions:
Avatar Storage (202): This function involves storing base avatars, which can be managed by the 5GS, a third-party entity, or locally on the user's devices. It ensures proper access to the base avatar 204 and related data, including authorization for avatar usage. Authentication functionality is responsible for mapping and identifying avatar ownership. A base avatar is a personalized avatar representation. The base avatar model may conform to a predetermined avatar representation format.
Avatar Animation (206): Based on the avatar representation format, this function retrieves the base avatar 204, receives format-specific animation data streams 208, and animates the avatar 210 for rendering. Some animation methods may bypass the three dimensional (3D) base avatar and directly produce a rendered two dimensional (2D) view.
Scene Management (212): This function creates and composes a shared 3D scene 214 for all participants. It integrates the user's avatar description, updates its position and orientation based on the user's movements, and adjusts properties like textures. The updated scene 214 is then shared with all participants.
Animation Data Generation (216): This function generates animation data 208 from raw signals 218, which can come from cameras, microphones, and motion-capturing devices. For example, it can convert video from a camera into facial feature points or audio from a microphone into text.
Base Avatar Generation (220): This function generates the base avatar using inputs such as video captured by a camera and other sensor information, possibly alongside a reference avatar 222. This process can be performed either online or offline.

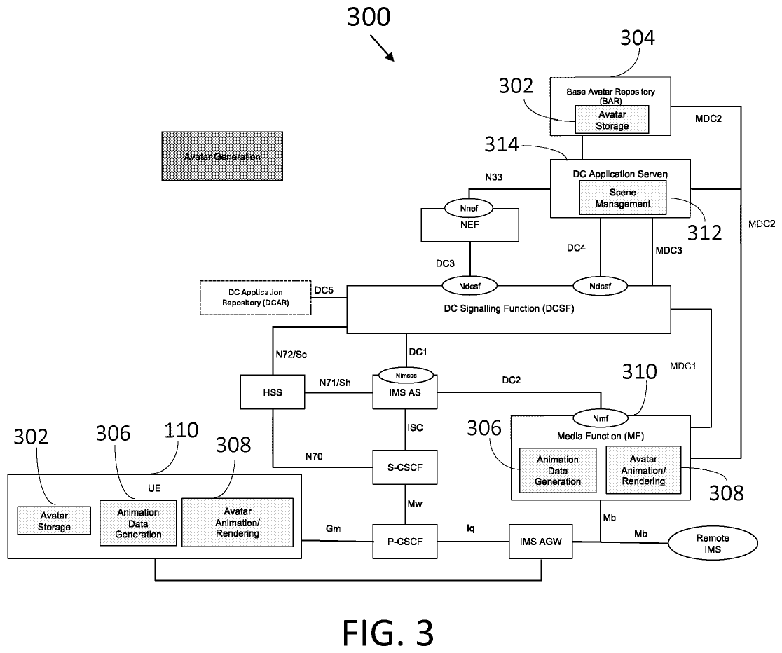

FIG. 3 illustrates the avatar functions mapped to different components in an IMS Data Channel (DC) architecture 300. IMS DC architecture is specified in technical specification (TS) 23.228. As illustrated, Avatar storage 302 can be part of the UE 110 or avatar storage 302 can be in the network as separate network element called “Base Avatar Repository” 304. Animation data generation 306 and Avatar animation/rendering 308 can be performed in the UE 110 or the IMS Media Function (MF) 310. Scene management function 312 is a part of the DC Application Server (AS) (DC-AS) 314.

Avatar animation 308 can be UE centric or network centric. In the UE centric case, avatar animation can be done by the source UE (UE1) or remote UE (UE2), and the UE (generally UE 110) animates and renders base avatar using animation data. In the network centric case, the IMS MF 310 animates and renders the UE1's base avatar using animation data. In either case, an IMS call setup and capability negotiation takes place before the animation starts. This includes exchanging capability information, media and metadata descriptions and formats. The involved entities agree on assignment of avatar generation, animation tasks and media requirements. Another embodiment includes where the DC-AS animates the avatar. When animation data is suspended from UE-1, the DC-AS can use the voice fallback or other fallback media as the source of animation data for 1) animating the avatar in the network or 2) sending animation data generated from the fallback to the UE-2.

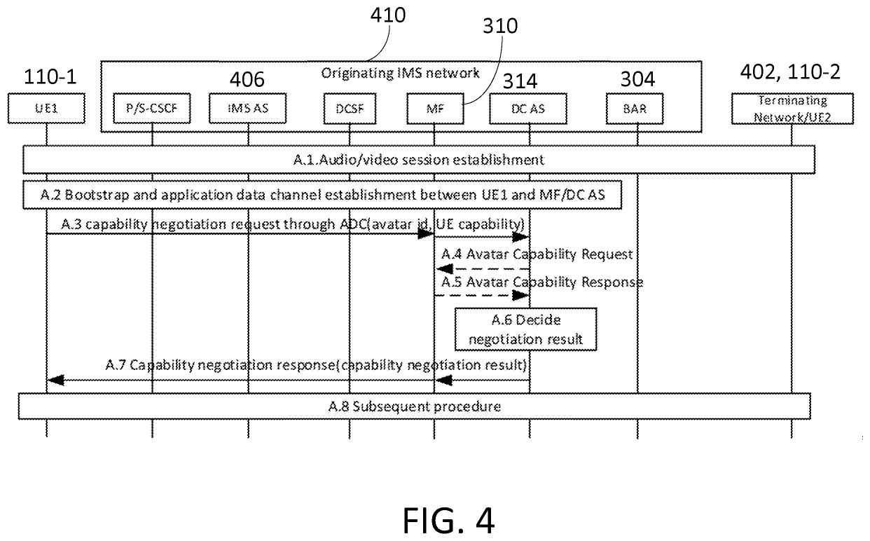

FIG. 4 illustrates the call setup and capability negotiation flow for network centric avatar animation.

For network centric mode, the capability negotiation procedure is based on the avatar type (2D or 3D) and the capability information of UE (UE 110-1 and UE 110-2) and MF 310. The capability information includes the animation data type(s) (e.g., text, expression data and motion signals for joints) supported by UE (110-1, 110-2) or MF 310. After capability negotiation, the IMS AS 406 instructs MF 310 to download UE1's base avatar from BAR 304, generate animation data by the source data received from UE1 110-1, and animate UE1's base avatar by the animation data received from UE1 110-1 or generated by MF 310 itself. Terminating network 402 may have the functionality of UE2 110-2.
A.1: An audio/video session is established between UE1 110-1 and UE2 110-2.
A.2: The bootstrap and application data channels are established between UE1 110-1 and IMS 410.
A.3: The UE1 110-1 sends a capability negotiation request using the application data channel through MF 310 to the DC AS 314. The message carries parameters including an avatar id chosen by UE1 110-1 and animation data types (e.g., text, expression data and motion signals for joints) supported by UE1 110-1.
A.4: The DC AS 312 sends an avatar capability request to MF 310.
A.5: The MF 310 responds with its avatar capability information to the DC AS 314.

The step A.4 and A.5 are optional. The DC AS 314 can decide MF's avatar capability based on its local configuration.

The service of avatar capability provided by MF 310 will be further defined in core network and terminals (CT) working group (WG) 1 (CT1) or CT WG 4 (CT4) if needed.
A.6: The DC AS 314 gets the avatar type (2D or 3D, from base avatar retrieved from BAR 304 or to be generated by the MF 310) by avatar id, and confirms the capability negotiation result based on the avatar type and the capability supported by UE1 110-1 and MF 310. The capability negotiation result includes the animation method (e.g., by audio, text or expression data and motion signals for joints).
A.7: The DC AS 314 sends the capability negotiation response to UE1 110 through MF 310. The message carries the capability negotiation result.
A.8: The subsequent procedure continues.

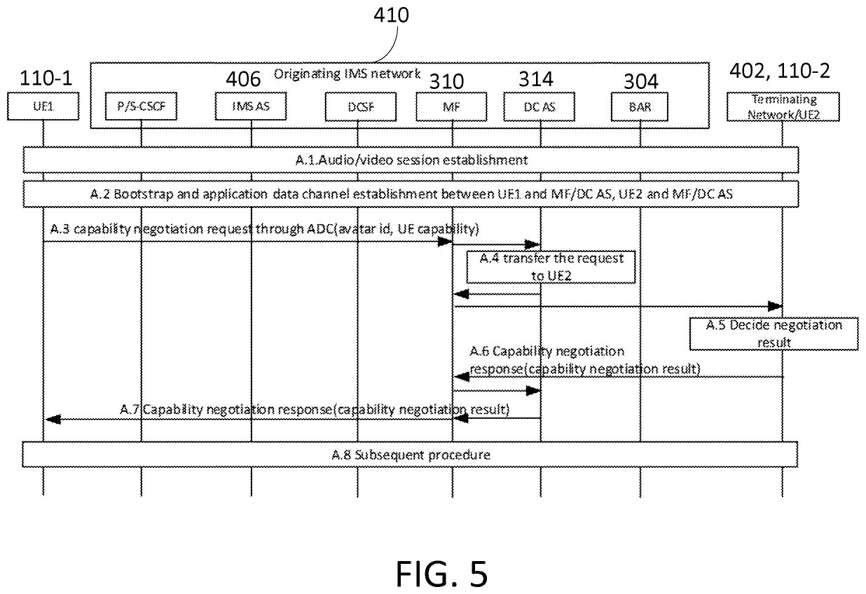

FIG. 5 illustrates the call setup and capability negotiation flow for UE centric avatar animation.

For UE centric mode, if UE1 centric procedure is used, there is no capability negotiation initialized by UE1 110-1, so only UE2 centric call flow is introduced. In UE2 centric procedure, the base avatar of UE1 110-1 is sent from MF 310 to UE2 110-2 using data channel, and the animation data is sent from UE1 110-1 or MF 310 to UE2 110-2 using real time transport protocol (RTP) or data channel.
A.1: An audio/video session is established between UE1 110-2 and UE2 110-2.
A.2: The bootstrap and application data channels are established between UE1 110-1 and IMS 410, UE2 110-2 and IMS 410.
A.3: The UE1 110-1 sends a capability negotiation request using the application data channel through MF 310 to the DC AS 314. The message carries an avatar id chosen by UE1 110-1 and the animation data types supported by UE1 110-1.
A.4: The DC AS 314 check if UE2 centric mode is used, then the DC AS 314 transfers the capability negotiation request to UE2 110-2 through MF 310. The request carries the animation data types supported by MF 310 in addition to the capability negotiation parameters.
A.5: The terminating network/UE2 (402, 110-2) finishes the capability negotiation.
A.6: The terminating network/UE2 (402, 110-2) returns the capability negotiation response carrying the negotiation result. The negotiation result includes the animation method (e.g., by audio, text or expression data and motion signals for joints).
A.7: The DC AS 314 transfers the capability negotiation response to UE1 110-1 through MF 110.
A.8: The subsequent procedure continues.

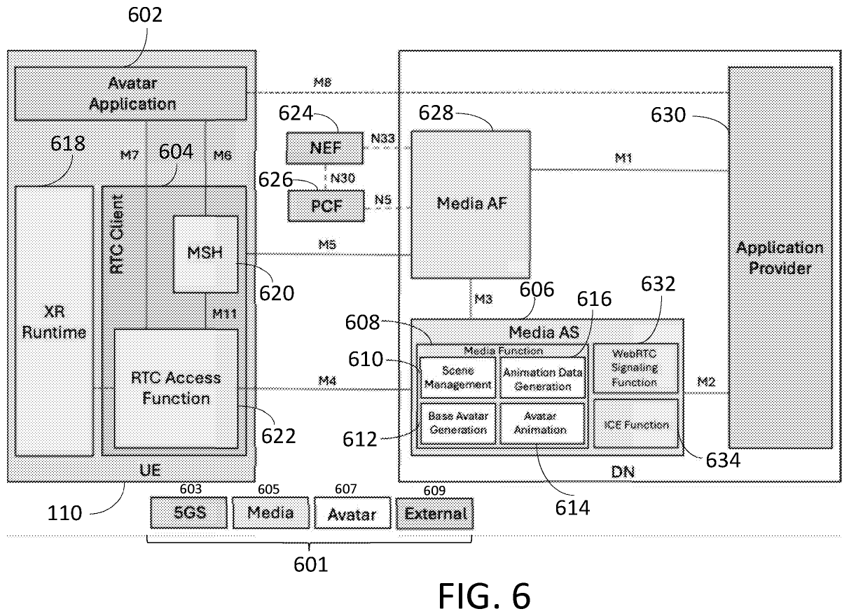

FIG. 6 depicts an RTC architecture for avatar-based communication. In this architecture, an RTC application for avatar-based communication (referred to as “Avatar Application” 602) interacts with an RTC Client 604 to establish WebRTC-based RTC sessions with a Media AS 606 that supports avatar functions. Although the Avatar Storage function is not depicted in FIG. 6, it can be part of the UE 110 or the RTC AS. The avatar functions supported by the Media Function 608 include:
Base Avatar Generation (612): The Media Function (MF) 608 can generate the base avatar using sensor data captured on the participant's UE 110 and make it available to the MF 608.
Animation Data Generation (616): The MF 608 can create an animation data stream based on the media received from the user, which can be applied to the base avatar to animate it.
Avatar Animation (614): The MF 608 can apply an animation stream, either generated locally within the MF 608 or received from the UE 110, to a base avatar to animate it.
Scene Management (610): The MF 608 can create and maintain a scene graph representation, placing avatars and other media objects within the scene.

In FIG. 6 items that correspond to 5GS 603 as given in the legend 601 include UE 110, network exposure function (NEF) 624, and policy control function (PCF) 626. Items that correspond to media 605 as given in the legend 601 include XR runtime 618, RTC client 604, media session handler (MSH) 620, RTC Access Function 622, media application function (AF) 628, media AS 606, media function 608, webRTC signaling function 632, and interactive connectivity establishment (ICE) function 634. Items that correspond to avatar 607 as given in the legend 601 include scene management 610, base avatar generation 612, animation data generation 616, and avatar animation 614. Items that correspond to external 609 as given in the legend 601 include avatar application 602, and application provider 630, as well as in some cases interfaces M7, M8, M11, M4, M5, N30, M8, N33, N5, M3, M1, and M2.

TR 26.813 lists key use cases for avatar communication, outlines the associated requirements for real-time rendering, encoding, and transmission of avatar data. The document further lists existing formats for avatar and animation representation, and procedures for realizing an avatar call using IMS and non-IMS based services. The avatar animation can occur on the source UE (UE1), in the network or on the remote UE (UE2). The TR includes text describing basic voice animation: “The 2D avatar may be animated by the user's voice or captured video in real-time and displayed on the screen of the peer user.”

The examples described herein may be used to implement voice animated avatar products.

In an avatar call, one or more UEs may use an avatar representation for the user. For simplicity, we consider a UE1 that has an avatar representation and captures input data for animation of the avatar. The avatar is rendered at a remote UE, UE2, during the avatar call. In reality, avatar calls can be bidirectional and multiparty.

Voice is an integral component in an avatar call that is always delivered. While voice can be used for animating an avatar, it may not always be the preferred choice as other sensors can create a richer animation. However, when other sensor input is unavailable, (e.g., the user moves out of view of the camera in cases of user video-based animation data generation, leaves the phone on the table while doing something else, etc.), voice can be used as fallback. It is possible for the sender (e.g., a UE or network function) of the animation data to simply switch to a new source data (e.g., from video to voice) for creating the animation data. However, in some cases the remote UE may do the voice animation locally when, for example:
UE1 and network cannot generate animation data from voice. If voice is transported UE-to-UE, the network may not have access to voice data for generating the animation data.
There is congestion on the network. Sending voice and animation data based on voice creates redundancy if the remote UE is capable of generating animation data based on voice. This may be more efficient even when there is no congestion.
No data channel for transport of animation data is available temporarily.

In an embodiment, a UE1 initiates an avatar call with one or more UE2 (the one or more UE2 may initiate the call with UE1) and establishes a data channel (DC) for avatar metadata exchange; sends over the DC a configuration message that indicates it has the capability to transform voice to animation data OR does not have the capability to transform voice to animation data; receives over the DC a configuration message that indicates UE2 has the capability to transform voice to animation data OR does not have the capability to transform voice to animation data. If UE2 has the capability to convert voice to animation data (or the network can convert voice to animation data) UE1 pauses sending animation data when sensor input is not available (UE2 detects no animation data and starts using voice). If UE2 does not have the capability to convert voice to animation data (or the network cannot convert voice to animation data) UE1 converts voice to animation data when sensor input is unavailable and sends the animation data and the voice data to UE2. The capability or inability of UE1 to convert voice data to animation data may be indicated with a binary flag, and the capability or inability of UE2 to convert voice data to animation data may be indicated with a binary flag.

In an embodiment the avatar call is established using the IMS architecture; the call establishment using Multimedia Telephony over IMS and the data channel for metadata exchange is an application data channel.

In an embodiment the avatar call is established using the RTC architecture; the data channel for metadata exchange is a WebRTC data channel. A real-time communication architecture encompasses both IMS based and 5G media streaming (5GMS) RTC based architectures.

In the above description and the remainder of this document we assume that UE1 (source UE) belongs to the user that the avatar represents and is consequently the UE that provides/generates/captures the data used for animating the avatar. UE2 (renderer UE) is the device used to render the animated avatar. In typical use cases the call is bidirectional and can be multiparty but only two UEs are assumed here for simplicity.

The examples described herein deviate from the prior art as the examples described herein allow a capability negotiation for the UEs to check if they have the capability of extracting animation data from voice and then dynamically switch between an avatar animation using animation data and voice-driven animation at the remote UE (UE2).

A configuration message for an avatar call is sent over the data channel indicating, e.g., the UE capabilities. Table 1 shows the new fields are added to the message.

TABLE 1
Example Avatar call configuration message

| Field | Type | Semantic |
|---|---|---|
| Avatar | Object | An object that defines configuration for avatars |
| | | to be used in a session. |
| mode | String | Defines if the UE is capable of sending or |
| | | receiving avatars. The field can have the |
| | | following values, that have the same semantics |
| | | as defined in request for comments (RFC) 4566. |
| | | “recvonly” |
| | | “sendonly” |
| | | “sendrecv” |
| | | In the simplified case unidirectional avatar call |
| | | case, UE1 will set this field to sendonly and UE2 |
| | | will set this field to recvonly. Typical use cases |
| | | are more likely to have sendrecv. |
| avatarObject | Object | The configuration object for the avatar |
| | | representation. There will be one for each avatar |
| | | in the call. |
| identifier | String | A URI to the avatar representation of the user. |
| animation_data_format | String | Format of the animation data that is supported by |
| | | the UE. |
| | | For UE1, this field would indicate the format |
| | | that it is capable of generating and sending. |
| | | For UE2, this field would indicate the format |
| | | that it is capable of parsing to animate the avatar. |
| | | This field may be defined as part of “Avatar” |
| | | object to indicate that it applies to all |
| | | avatarObject instances within the message. |
| voice_fallback | String | An identifier of an audio stream that should be |
| | | used for animating the avatar when animation |
| | | data is not available. For example, the |
| | | synchronization source (SSRC), contributing |
| | | source (CSRC) (e.g., CSRC can be used when a |
| | | middle box combines audio from multiple UEs, |
| | | and a particular audio CSRC needs to be mapped |
| | | to an avatar) and/or mid (media identifier as |
| | | defined in RFC 5888) of an audio RTP stream as |
| | | advertised in the session description protocol |
| | | (SDP) offer/answer of the call. |
| | | If the parameter is not included, then voice |
| | | shouldn't be used to animate the avatar. |
| | | When the message is sent by UE1, if |
| | | voice_fallback is included but |
| | | animation_data_format is not (or is set to NULL) |
| | | then the device is not capable of generating |
| | | animation data and voice should be used for |
| | | generating the animation data for animating the |
| | | avatar (in the network or at UE2). |
| | | If the message is sent by UE2 when this value is |
| | | not known, it can be set to an empty string to |
| | | indicate that voice animation can be done on |
| | | UE2 and UE1 should provide an identifier. |
| altsource | object | When a generic alternative source is to be |
| | | indicated, this parameter can be used. It can have |
| | | one or more of the following fields: |
| | | Format: Format of the alternative source, e.g., |
| | | audio, video, pre-defined animation etc. |
| | | Source: The source stream of the alternative |
| | | source, e.g., SSRC, CSRC, mid, uniform |
| | | resource identifier (URI), etc. |
| | | Duration: For a predefined animation source, the |
| | | duration of the source stream, e.g., milliseconds |
| | | or microseconds for a video clip. |
| | | Loop: A flag to indicate if the source is to run in |
| | | a loop. |
| | | The parameter can be used in a similar way to |
| | | voice_fallback to indicate capability as well as |
| | | define an alternative source. |

In an embodiment, UE2 may detect a pause in animation stream implicitly, i.e., there is no explicit signal to indicate there is a pause but the UE2 can detect it if it stops receiving animation data. The UE2 can then fallback to using voice for animation.

In another embodiment, UE1 signals a pause in animation stream when the animation data stream is temporarily unavailable with a message over the data channel. Such a message can have the uniform resource name (URN) urn:3gpp:avatar: v:suspend. The receiver of the message (MF or UE2) may switch to voice_fallback if a source audio was already negotiated in the configuration messages. The Message object in this case may contain:

TABLE 2
Example Animation data suspend message

| | | Cardi- | |
|---|---|---|---|
| Name | Type | nality | Description |
| id | string | 1 . . . 1 | A unique identifier of the |
| | | | message in the scope of the data |
| | | | channel session. |
| Type | string | 1 . . . 1 | A URN that identifies the |
| | | | message type. For the animation |
| | | | data pause message type as |
| | | | explained herein, the URN can be |
| | | | urn:3gpp:avatar:v1:suspend |
| Reason | string | 0 . . . 1 | Reason: e.g., |
| | | | “sensor input |
| | | | unavailable”, |
| | | | “low-confidence |
| | | | for sensor data”, |
| | | | “network issues” |
| startTime | number | 0 . . . 1 | Start time of the disruption |
| endTime | number | 0 . . . 1 | end time of the disruption if |
| | | | known |
| voice_fallback | object | 0 . . . 1 | An object that defines the voice |
| | | | fallback to use, e.g., with an mid |
| | | | or SSRC or a URI for a pre- |
| | | | recorded audio stream. |
| altsource | object | 0 . . . 1 | When a generic alternative |
| | | | source is to be indicated, this |
| | | | parameter can be used. It can |
| | | | have one or more of the |
| | | | following fields: |
| | | | Format: Format of the alternative |
| | | | source, e.g., audio, video, pre- |
| | | | defined animation etc. |
| | | | Source: The source stream of the |
| | | | alternative source, e.g., SSRC, |
| | | | CSRC, mid, URI, etc. |
| | | | Duration: For a predefined |
| | | | animation source, the duration of |
| | | | the source stream, e.g., |
| | | | milliseconds or microseconds for |
| | | | a video clip. |
| | | | Loop: A flag to indicate if the |
| | | | source is to run in a loop. |
| Message | object | 1 . . . 1 | The message content depends on |
| | | | the message type. |

Reason: e.g., “sensor input unavailable”, “low-confidence for sensor data”, “network issues”
Start time of the disruption and end time (if known).
Preferred alternate source for animation e.g., audio and mid for an audio RTP stream. predefined screensaver animation (could run in a loop).

In an embodiment, the audio stream can be pre-recorded or generated live or artificial intelligence (AI) generated.

In an embodiment, The SDP offer/answer may include a new attribute under the media line for the audio that is to be used for animating the avatar:

a=avatar_voice_fallback

UE1 may include in the SDP offer the avatar_voice_fallback attribute in the media description of the audio stream that could be used for avatar animation. UE2 may either accept the offer by leaving the attribute unchanged in the SDP answer or remove the attribute in the SDP answer, if it is not capable of performing audio-driven animation, or cannot/does not wish to use the offered fallback audio stream for animation.

In another embodiment, the source data for the voice fallback can be indicated using scene description. MPEG-SD (moving picture experts group scene description) extension MPEG_Audio_spatial can be used to indicate the associated audio for an avatar object. The MPEG_accessor_timed can be used for specifying the associated accessor as an RTP stream. The “extras” field of the MPEG_Audio_spatial node contains the field “voice_fallback”.

Digital avatar representations for storage and transmission over communication networks may comprise a base avatar and supported animation formats within an avatar representation object, wherein inclusion of supported animation formats indicates that the base avatar representation can be animated with animation data conforming to one of the supported animation formats.

In an embodiment, during the avatar call session set up, the rendering UE, i.e. UE2: receives an indication of the location of an avatar representation object corresponding to UE1, retrieves the avatar representation object corresponding to UE1, parses the animation formats comprised within the avatar representation object, sends an indication of avatar animation formats that UE2 supports to UE1 (or the network), wherein the indication comprises: an animation format, one or more animation source data formats and an indication of UE2's ability to generate animation data conformant to the indicated animation format from each of the indicated animation source data formats.

In an embodiment, the indication further comprises one or more fallback animation formats and for each indicated fallback animation format, one or more animation source data formats and an indication of UE2's ability to generate animation data conformant to the indicated animation format from each of the indicated animation source data formats.

An avatar communication session between UE1 and UE2 may comprise UE2 receiving a scene description, for example MPEG-I Scene Description, from a network element (for example, from an IMS DC MF or DC-AS or a 5GMS application server) which describes a virtual scene in which to place avatars corresponding to UE1 and UE2, for example using the “MPEG_node_avatar” extension of MPEG-I SD. Such a scene description may comprise animation streams or animation data.

In an embodiment, during the avatar call session set up, the rendering UE, i.e. UE2: receives a scene description resource comprising: an indication of an avatar representation object corresponding to UE1, and one or more animation streams or a location thereof associated with the avatar representation object corresponding to UE1, retrieves the avatar representation object corresponding to UE1, parses the animation formats comprised within the avatar representation object, sends an indication of avatar animation formats that UE2 supports to UE1 (or the network), wherein the indication comprises: an animation format, source data formats and an indication of UE2's ability to generate animation data conformant to the indicated animation format from each of the indicated animation source data formats, and an indication to use an animation stream or animation data comprised in the scene description for fall back animation.

In an embodiment, the indication to use an animation stream or animation data comprised in the scene description for fallback animation further comprises one or more of: parameters to activate the fallback animation, and media stream to generate control information to control the fallback animation.

An example of parameters to activate fallback animation could be an explicit indication from UE1, for example, as urn:3gpp:avatar:v1:suspend. Or implicitly the pause of transmission of animation data from UE1.

The fallback animation may resume to normal operation, for example when the sensor input is available after a period of disruption. This resume may be explicitly signaled via a message. For example, urn:3gpp:avatar:v1:resume.

In an embodiment, the paused animation is determined by a minimum threshold T. For example, the inactivity of the sensor input for at least T ms, may lead to conclude that the sensor in unavailable and trigger the fallback procedure of using an audio stream as input for animating the avatar. The threshold T avoids incurring into false fallbacks procedures.

The media stream to generate control information for fallback animation may be indicated as illustrated in Table 1 or Table 2.

In some embodiments, the control information to control for fallback animation may be semantic data. UE2 may receive such semantic data from UE1 or a network entity or UE2 may generate semantic data from a media stream, for example by using text to speech recognition (on audio streams) or sentiment analysis (on audio, text streams or images).

In an embodiment, the fallback information (indicated as altsource or voice fallback) is a list containing multiple fallback or supported sources. In an embodiment, the list is ordered by preference of the application, content type or the UE.

Explicit signaling for detection of voice fallback can be implemented. A fallback source in action can be detected implicitly by temporarily suspending the animation data from a UE1, the primary animation data source.

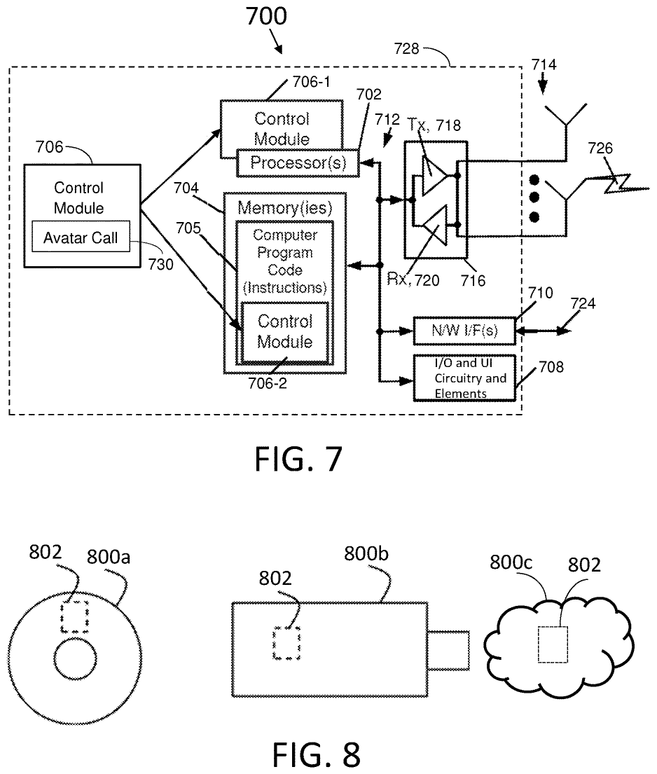

FIG. 7 is an example apparatus 700, which may be implemented in hardware, configured to implement the examples described herein. The apparatus 700 comprises at least one processor 702 (e.g. a field programmable gate array (FPGA) and/or central processing unit (CPU)), one or more memories 704 including computer program code 705, the computer program code 705 having instructions to carry out the methods described herein, wherein the at least one memory 704 and the computer program code 705 are configured to, with the at least one processor 702, cause the apparatus 700 to implement circuitry, a process, component, module, or function (implemented with control module 706) to implement the examples described herein. The memory 704 may be a non-transitory memory, a transitory memory, a volatile memory (e.g. random access memory (RAM)), or a non-volatile memory (e.g. read only memory (ROM)).

Avatar call 730 implements the examples described herein directed to dynamic animation source for avatar calls.

The apparatus 700 includes a display and/or input/output (I/O) interface 708, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 700 includes one or more communication e.g. network (N/W) interfaces (I/F(s)) 710. The communication I/F(s) 710 may be wired and/or wireless and communicate over the Internet/other network(s) via any communication technique including via one or more links 724. The link(s) 724 may be the link(s) 131 and/or 176 from FIG. 1. The link(s) 131 and/or 176 from FIG. 1 may also be implemented using transceiver(s) 716 and corresponding wireless link(s) 726. The communication I/F(s) 710 may comprise one or more transmitters or one or more receivers.

The transceiver 716 comprises one or more transmitters 718 and one or more receivers 720. The transceiver 716 and/or communication I/F(s) 710 may comprise standard well-known components such as an amplifier, filter, frequency-converter, (de)modulator, and encoder/decoder circuitries and one or more antennas, such as antennas 714 used for communication over wireless link 726.

The control module 706 of the apparatus 700 comprises one of or both parts 706-1 and/or 706-2, which may be implemented in a number of ways. The control module 706 may be implemented in hardware as control module 706-1, such as being implemented as part of the one or more processors 702. The control module 706-1 may be implemented also as an integrated circuit or through other hardware such as a programmable gate array. In another example, the control module 706 may be implemented as control module 706-2, which is implemented as computer program code (having corresponding instructions) 705 and is executed by the one or more processors 702. For instance, the one or more memories 704 store instructions that, when executed by the one or more processors 702, cause the apparatus 700 to perform one or more of the operations as described herein. Furthermore, the one or more processors 702, the one or more memories 704, and example algorithms (e.g., as flowcharts and/or signaling diagrams), encoded as instructions, programs, or code, are means for causing performance of the operations described herein.

The apparatus 700 to implement the functionality of control 706 may be UE 110, RAN node 170 (e.g. gNB), or network element(s) 190 (e.g. LMF 190). Thus, processor 702 may correspond to processor(s) 120, processor(s) 152 and/or processor(s) 175, memory 704 may correspond to one or more memories 125, one or more memories 155 and/or one or more memories 171, computer program code 705 may correspond to computer program code 123, computer program code 153, and/or computer program code 173, control module 706 may correspond to module 140-1, module 140-2, module 150-1, and/or module 150-2, and communication I/F(s) 710 and/or transceiver 716 may correspond to transceiver 130, antenna(s) 128, transceiver 160, antenna(s) 158, N/W I/F(s) 161, and/or N/W I/F(s) 180. Alternatively, apparatus 700 and its elements may not correspond to either of UE 110, RAN node 170, or network element(s) 190 and their respective elements, as apparatus 700 may be part of a self-organizing/optimizing network (SON) node or other node, such as a node in a cloud.

Apparatus 700 may correspond to UE1 110-1 or UE2 110-2, or any of the other apparatuses described herein.

The apparatus 700 may also be distributed throughout the network (e.g. 100) including within and between apparatus 700 and any network element (such as a network control element (NCE) 190 and/or the RAN node 170 and/or UE 110).

Interface 712 enables data communication and signaling between the various items of apparatus 700, as shown in FIG. 7. For example, the interface 712 may be one or more buses such as address, data, or control buses, and may include any interconnection mechanism, such as a series of lines on a motherboard or integrated circuit, fiber optics or other optical communication equipment, and the like. Computer program code (e.g. instructions) 705, including control 706 may comprise object-oriented software configured to pass data or messages between objects within computer program code 705. The apparatus 700 need not comprise each of the features mentioned, or may comprise other features as well. The various components of apparatus 700 may at least partially reside in a common housing 728, or a subset of the various components of apparatus 700 may at least partially be located in different housings, which different housings may include housing 728.

FIG. 8 shows a schematic representation of non-volatile memory media 800a (e.g. computer/compact disc (CD) or digital versatile disc (DVD)) and 800b (e.g. universal serial bus (USB) memory stick) and 800c (e.g. cloud storage for downloading instructions and/or parameters 802 or receiving emailed instructions and/or parameters 802) storing instructions and/or parameters 802 which when executed by a processor allows the processor to perform one or more of the steps of the methods described herein. Instructions and/or parameters 802 may represent a non-transitory computer readable medium.

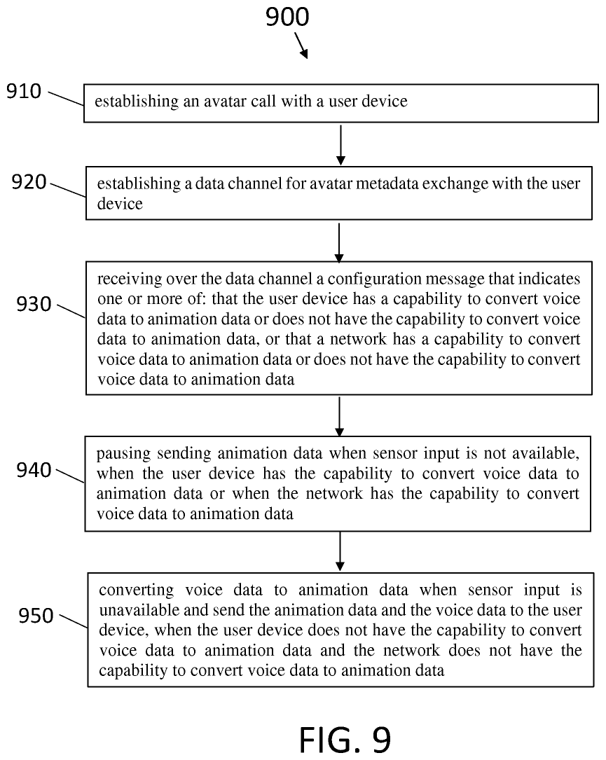

FIG. 9 is an example method 900, based on the example embodiments described herein. At 910, the method includes establishing an avatar call with a user device. At 920, the method includes establishing a data channel for avatar metadata exchange with the user device. At 930, the method includes receiving over the data channel a configuration message that indicates one or more of: that the user device has a capability to convert voice data to animation data or does not have the capability to convert voice data to animation data, or that a network has a capability to convert voice data to animation data or does not have the capability to convert voice data to animation data. At 940, the method includes pausing sending animation data when sensor input is not available, when the user device has the capability to convert voice data to animation data or when the network has the capability to convert voice data to animation data. At 950, the method includes converting voice data to animation data when sensor input is unavailable and send the animation data and the voice data to the user device, when the user device does not have the capability to convert voice data to animation data and the network does not have the capability to convert voice data to animation data. Method 900 may be implemented with UE 110, UE1 110-1, UE2 110-2, or apparatus 700.

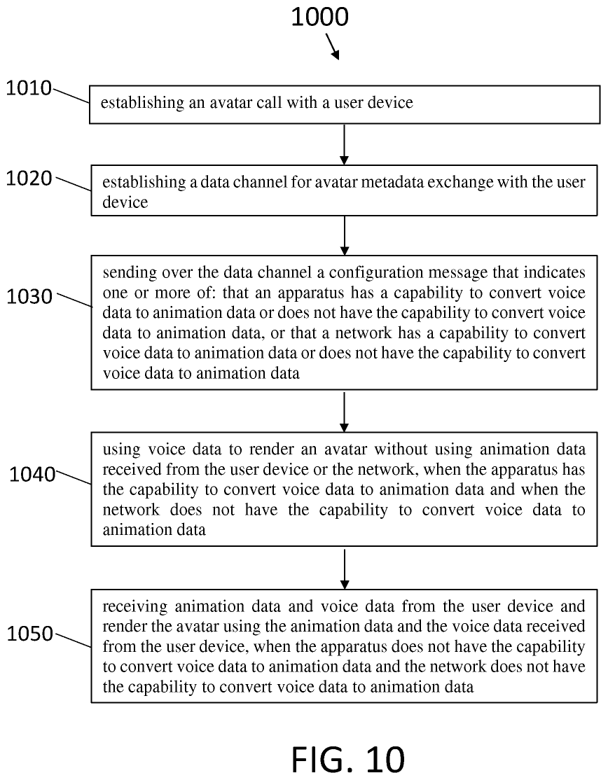

FIG. 10 is an example method 1000, based on the example embodiments described herein. At 1010, the method includes establishing an avatar call with a user device. At 1020, the method includes establishing a data channel for avatar metadata exchange with the user device. At 1030, the method includes sending over the data channel a configuration message that indicates one or more of: that an apparatus has a capability to convert voice data to animation data or does not have the capability to convert voice data to animation data, or that a network has a capability to convert voice data to animation data or does not have the capability to convert voice data to animation data. At 1040, the method includes using voice data to render an avatar without using animation data received from the user device or the network, when the apparatus has the capability to convert voice data to animation data and when the network does not have the capability to convert voice data to animation data. At 1050, the method includes receiving animation data and voice data from the user device and render the avatar using the animation data and the voice data received from the user device, when the apparatus does not have the capability to convert voice data to animation data and the network does not have the capability to convert voice data to animation data. Method 1000 may be implemented with UE 110, UE1 110-1, UE2 110-2, or apparatus 700.

The following examples are provided and described herein.

Example 1. An apparatus including: at least one processor; and at least one memory storing instructions that, when executed by the at least one processor, cause the apparatus at least to: establish an avatar call with a user device; establish a data channel for avatar metadata exchange with the user device; receive over the data channel a configuration message that indicates one or more of: that the user device has a capability to convert voice data to animation data or does not have the capability to convert voice data to animation data, or that a network has a capability to convert voice data to animation data or does not have the capability to convert voice data to animation data; pause sending animation data when sensor input is not available, when the user device has the capability to convert voice data to animation data or when the network has the capability to convert voice data to animation data; and convert voice data to animation data when sensor input is unavailable and send the animation data and the voice data to the user device, when the user device does not have the capability to convert voice data to animation data and the network does not have the capability to convert voice data to animation data.

Example 2. The apparatus of example 1, wherein the avatar call is established using multimedia telephony over internet protocol multimedia subsystem, and the data channel for avatar metadata exchange comprises an application data channel.

Example 3. The apparatus of example 1, wherein the avatar call is established using a real-time communication architecture, and the data channel for avatar metadata exchange comprises a real-time communication data channel.

Example 4. The apparatus of any of examples 1 to 3, wherein the pausing of the sending of the animation data provides an implicit signal to the user device that there is a pause in an animation data stream, and wherein the apparatus does not provide to the user device an explicit signal that there is the pause in the animation data stream.

Example 5. The apparatus of any of examples 1 to 4, wherein the at least one memory stores instructions that, when executed by the at least one processor, cause the apparatus at least to: signal a pause in an animation data stream when the animation data stream is temporarily unavailable with a message over the data channel.

Example 6. The apparatus of any of examples 1 to 5, wherein the at least one memory stores instructions that, when executed by the at least one processor, cause the apparatus at least to: transmit an indication of an identifier of an audio stream that should be used for animating the avatar when animation data is not available.

Example 7. The apparatus of example 6, wherein the audio stream is pre-recorded or generated live or AI generated.

Example 8. The apparatus of any of examples 1 to 7, wherein the at least one memory stores instructions that, when executed by the at least one processor, cause the apparatus at least to: include in a session description protocol offer an attribute in a media description of an audio stream that can be used for avatar animation.

Example 9. The apparatus of any of examples 1 to 8, wherein the at least one memory stores instructions that, when executed by the at least one processor, cause the apparatus at least to: receive, from the user device, an indication of avatar animation formats that the user device supports; wherein the indication of avatar animation formats that the user device supports comprises: an animation format, source data formats and an indication of an ability of the user device to generate animation data conformant to the indicated animation format from each of the indicated animation source data formats, and an indication to use an animation data stream or animation data comprised in a scene description for fallback animation.

Example 10. The apparatus of example 9, wherein the indication to use the animation data stream or animation data comprised in the scene description for fallback animation comprises one or more of: parameters to activate the fallback animation, or a media stream to generate control information to control the fallback animation.

Example 11. The apparatus of example 1, wherein the at least one memory stores instructions that, when executed by the at least one processor, cause the apparatus at least to: send over the data channel a configuration message (which configuration message can be sent before or after the configuration message of Example 1 is received) that indicates one or more of: that the apparatus has a capability to convert voice data to animation data or does not have the capability to convert voice data to animation data, or that the network has the capability to convert voice data to animation data or does not have the capability to convert voice data to animation data.

Example 12. An apparatus including: at least one processor; and at least one memory storing instructions that, when executed by the at least one processor, cause the apparatus at least to: establish an avatar call with a user device; establish a data channel for avatar metadata exchange with the user device; send over the data channel a configuration message that indicates one or more of: that the apparatus has a capability to convert voice data to animation data or does not have the capability to convert voice data to animation data, or that a network has a capability to convert voice data to animation data or does not have the capability to convert voice data to animation data; use voice data to render an avatar without using animation data received from the user device or the network, when the apparatus has the capability to convert voice data to animation data and when the network does not have the capability to convert voice data to animation data; and receive animation data and voice data from the user device and render the avatar using the animation data and the voice data received from the user device, when the apparatus does not have the capability to convert voice data to animation data and the network does not have the capability to convert voice data to animation data.

Example 13. The apparatus of example 12, wherein the avatar call is established using multimedia telephony over internet protocol multimedia subsystem, and the data channel for avatar metadata exchange comprises an application data channel.

Example 14. The apparatus of example 12, wherein the avatar call is established using a real-time communication architecture, and the data channel for avatar metadata exchange comprises a real-time communication data channel.

Example 15. The apparatus of any of examples 12 to 14, wherein the at least one memory stores instructions that, when executed by the at least one processor, cause the apparatus at least to: detect a pause in an animation data stream implicitly when the apparatus stops receiving animation data; wherein the apparatus does not receive an explicit signal that there is a pause in the animation data stream; and determine to fall back to using voice data for animation of the avatar, in response to detecting the pause in the animation data stream implicitly when the apparatus stops receiving animation data.

Example 16. The apparatus of any of examples 12 to 15, wherein the at least one memory stores instructions that, when executed by the at least one processor, cause the apparatus at least to: receive signaling of a pause in an animation data stream when the animation data stream is temporarily unavailable with a message over the data channel; and switch to using voice data to render the avatar when a source audio was negotiated in at least one of the received configuration message or the sent configuration message.

Example 17. The apparatus of any of examples 12 to 16, wherein the at least one memory stores instructions that, when executed by the at least one processor, cause the apparatus at least to: receive an indication of an identifier of an audio stream that should be used for animating the avatar when animation data is not available.

Example 18. The apparatus of example 17, wherein the audio stream is pre-recorded or generated live or AI generated.

Example 19. The apparatus of any of examples 12 to 18, wherein the at least one memory stores instructions that, when executed by the at least one processor, cause the apparatus at least to: receive in a session description protocol offer an attribute in a media description of an audio stream that can be used for avatar animation; and perform one of: accept the offer by leaving the attribute unchanged in a session description protocol answer, or remove the attribute in the session description protocol answer, when the apparatus is not capable of performing audio-driven animation, or cannot or does not want to use the offered fallback audio stream for animation.

Example 20. The apparatus of any of examples 12 to 19, wherein the at least one memory stores instructions that, when executed by the at least one processor, cause the apparatus at least to: receive a scene description resource corresponding to a scene description, the scene description resource comprising: an indication of an avatar representation object corresponding to the user device, and at least one animation data stream associated with the avatar representation object corresponding to the user device, or a location of at least one animation data stream associated with the avatar representation object corresponding to the user device; retrieve the avatar representation object corresponding to the user device; parse animation formats comprised within the avatar representation object; and send, to the user device or the network, an indication of avatar animation formats that the apparatus supports; wherein the indication of avatar animation formats that the apparatus supports comprises: an animation format, source data formats and an indication of an ability of the apparatus to generate animation data conformant to the indicated animation format from each of the indicated animation source data formats, and an indication to use an animation data stream or animation data comprised in the scene description for fallback animation.

Example 21. The apparatus of example 20, wherein the indication to use an animation data stream or animation data comprised in the scene description for fallback animation comprises one or more of: parameters to activate the fallback animation, or a media stream to generate control information to control the fallback animation.

Example 22. The apparatus of example 12, wherein the at least one memory stores instructions that, when executed by the at least one processor, cause the apparatus at least to: receive over the data channel a configuration message (which configuration message can be received before or after the configuration message of Example 12 is sent) that indicates one or more of: that the user device has a capability to convert voice data to animation data or does not have the capability to convert voice data to animation data, or that the network has the capability to convert voice data to animation data or does not have the capability to convert voice data to animation data.

Example 23. A method including: establishing an avatar call with a user device; establishing a data channel for avatar metadata exchange with the user device; receiving over the data channel a configuration message that indicates one or more of: that the user device has a capability to convert voice data to animation data or does not have the capability to convert voice data to animation data, or that a network has a capability to convert voice data to animation data or does not have the capability to convert voice data to animation data; pausing sending animation data when sensor input is not available, when the user device has the capability to convert voice data to animation data or when the network has the capability to convert voice data to animation data; and converting voice data to animation data when sensor input is unavailable and send the animation data and the voice data to the user device, when the user device does not have the capability to convert voice data to animation data and the network does not have the capability to convert voice data to animation data.

Example 24. A method including: establishing an avatar call with a user device; establishing a data channel for avatar metadata exchange with the user device; sending over the data channel a configuration message that indicates one or more of: that an apparatus has a capability to convert voice data to animation data or does not have the capability to convert voice data to animation data, or that a network has a capability to convert voice data to animation data or does not have the capability to convert voice data to animation data; using voice data to render an avatar without using animation data received from the user device or the network, when the apparatus has the capability to convert voice data to animation data and when the network does not have the capability to convert voice data to animation data; and receiving animation data and voice data from the user device and render the avatar using the animation data and the voice data received from the user device, when the apparatus does not have the capability to convert voice data to animation data and the network does not have the capability to convert voice data to animation data.

Example 25. An apparatus including: means for establishing an avatar call with a user device; means for establishing a data channel for avatar metadata exchange with the user device; means for receiving over the data channel a configuration message that indicates one or more of: that the user device has a capability to convert voice data to animation data or does not have the capability to convert voice data to animation data, or that a network has a capability to convert voice data to animation data or does not have the capability to convert voice data to animation data; means for pausing sending animation data when sensor input is not available, when the user device has the capability to convert voice data to animation data or when the network has the capability to convert voice data to animation data; and means for converting voice data to animation data when sensor input is unavailable and send the animation data and the voice data to the user device, when the user device does not have the capability to convert voice data to animation data and the network does not have the capability to convert voice data to animation data.

Example 26. An apparatus including: means for establishing an avatar call with a user device; means for establishing a data channel for avatar metadata exchange with the user device; means for sending over the data channel a configuration message that indicates one or more of: that the apparatus has a capability to convert voice data to animation data or does not have the capability to convert voice data to animation data, or that a network has a capability to convert voice data to animation data or does not have the capability to convert voice data to animation data; means for using voice data to render an avatar without using animation data received from the user device or the network, when the apparatus has the capability to convert voice data to animation data and when the network does not have the capability to convert voice data to animation data; and means for receiving animation data and voice data from the user device and render the avatar using the animation data and the voice data received from the user device, when the apparatus does not have the capability to convert voice data to animation data and the network does not have the capability to convert voice data to animation data.

Example 27. A computer readable medium including instructions stored thereon for performing at least the following: establishing an avatar call with a user device; establishing a data channel for avatar metadata exchange with the user device; receiving over the data channel a configuration message that indicates one or more of: that the user device has a capability to convert voice data to animation data or does not have the capability to convert voice data to animation data, or that a network has a capability to convert voice data to animation data or does not have the capability to convert voice data to animation data; pausing sending animation data when sensor input is not available, when the user device has the capability to convert voice data to animation data or when the network has the capability to convert voice data to animation data; and converting voice data to animation data when sensor input is unavailable and send the animation data and the voice data to the user device, when the user device does not have the capability to convert voice data to animation data and the network does not have the capability to convert voice data to animation data.

Example 28. A computer readable medium including instructions stored thereon for performing at least the following: establishing an avatar call with a user device; establishing a data channel for avatar metadata exchange with the user device; sending over the data channel a configuration message that indicates one or more of: that an apparatus has a capability to convert voice data to animation data or does not have the capability to convert voice data to animation data, or that a network has a capability to convert voice data to animation data or does not have the capability to convert voice data to animation data; using voice data to render an avatar without using animation data received from the user device or the network, when the apparatus has the capability to convert voice data to animation data and when the network does not have the capability to convert voice data to animation data; and receiving animation data and voice data from the user device and render the avatar using the animation data and the voice data received from the user device, when the apparatus does not have the capability to convert voice data to animation data and the network does not have the capability to convert voice data to animation data.

There are several use cases covered by the herein described embodiments. These use cases include, among others, cases 1-8 below.

In a first case, UE1 110-1 receives a configuration message that indicates that UE2 110-2 has a capability to convert voice data to animation data and that does not indicate any capability or inability of the network 402 to convert voice data to animation data. In this first case, UE1 110-1 pauses sending animation data to UE2 110-2 when sensor input is not available.

In a second case, UE1 110-1 receives a configuration message that indicates that UE2 110-2 does not have a capability to convert voice data to animation data and that does not indicate any capability or inability of the network 402 to convert voice data to animation data. In this second case, UE1 110-1 converts voice data to animation data when sensor input is not available and sends the animation data and the voice data to UE2 110-2.

In a third case, UE1 110-1 receives a configuration message that does not indicate any capability or inability of UE2 110-2 to convert voice data to animation data and that indicates that the network 402 has a capability to convert voice data to animation data. In this third case, UE1 110-1 pauses sending animation data to UE2 110-2 when sensor input is not available.

In a fourth case, UE1 110-1 receives a configuration message that does not indicate any capability or inability of UE2 110-2 to convert voice data to animation data and that indicates that the network 402 does not have a capability to convert voice data to animation data. In this fourth case, UE1 110-1 converts voice data to animation data when sensor input is not available and sends the animation data and the voice data to UE2 110-2.

In a fifth case, UE1 110-1 receives a configuration message that indicates that UE2 110-2 does not have a capability to convert voice data to animation data and that indicates that the network 402 does not have a capability to convert voice data to animation data. In this fifth case, UE1 110-1 converts voice data to animation data when sensor input is not available and sends the animation data and the voice data to UE2 110-2.

In a sixth case, UE1 110-1 receives a configuration message that indicates that UE2 110-2 does not have a capability to convert voice data to animation data and that indicates that the network 402 does have a capability to convert voice data to animation data. In this sixth case, UE1 110-1 pauses sending animation data to UE2 110-2 when sensor input is not available.

In a seventh case, UE1 110-1 receives a configuration message that indicates that UE2 110-2 does have a capability to convert voice data to animation data and that indicates that the network 402 does not have a capability to convert voice data to animation data. In this seventh case, UE1 110-1 pauses sending animation data to UE2 110-2 when sensor input is not available.

In an eighth case, UE1 110-1 receives a configuration message that indicates that UE2 110-2 does have a capability to convert voice data to animation data and that indicates that the network 402 does have a capability to convert voice data to animation data. In this eighth case, UE1 110-1 pauses sending animation data to UE2 110-2 when sensor input is not available.

References to a ‘computer’, ‘processor’, etc. should be understood to encompass not only computers having different architectures such as single/multi-processor architectures and sequential or parallel architectures but also specialized circuits such as FPGAs, application specific integrated circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

The term “non-transitory,” as used herein, is a limitation of the medium itself (i.e., tangible, not a signal) as opposed to a limitation on data storage persistency (e.g., RAM vs. ROM).

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

What is claimed is:

1. An apparatus comprising:
at least one processor, and
at least one memory storing instructions that, when executed by the at least one processor, cause the apparatus at least to:
establish an avatar call with a user device,
establish a data channel for avatar metadata exchange with the user device,
send over the data channel a configuration message that indicates an animation fallback comprising a list of uniform resource names indicating supported animation data to be used as a fallback for animating an avatar when a selected animation stream stops, and
send over the data channel a stopped message when the selected animation stream becomes temporarily unavailable, the stopped message comprising a type field set to a uniform resource name that identifies the stopped message.

2. The apparatus of claim 1, wherein the stopped message further comprises a reason field indicating a cause of disruption in the selected animation stream.

3. The apparatus of claim 2, wherein the reason field comprises one of: device error, low-confidence for sensor data, or network issues.

4. The apparatus of claim 1, wherein the stopped message further comprises a media identifier value of an audio stream used as the fallback when the selected animation stream stops.

5. The apparatus of claim 1, wherein the stopped message further comprises a start time field indicating a start time of suspension of animation data.

6. The apparatus of claim 1, wherein the stopped message further comprises an end time field indicating an end time of suspension of animation data.

7. The apparatus of claim 1, wherein the at least one memory stores instructions that, when executed by the at least one processor, cause the apparatus at least to:
send over the data channel a resumed message when the selected animation stream becomes available again, the resumed message comprising a type field set to a uniform resource name that identifies the resumed message.

8. The apparatus of claim 1, wherein the avatar call is established using multimedia telephony over internet protocol multimedia subsystem, and the data channel for avatar metadata exchange comprises an application data channel.

9. The apparatus of claim 1, wherein the avatar call is established using a real-time communication architecture, and the data channel for avatar metadata exchange comprises a real-time communication data channel.

10. The apparatus of claim 1, wherein the animation fallback comprises an audio stream uniform resource name.

11. The apparatus of claim 1, wherein the at least one memory stores instructions that, when executed by the at least one processor, cause the apparatus at least to:
receive over the data channel a response message that indicates a selected animation fallback from the list of uniform resource names.

12. An apparatus comprising:
at least one processor, and
at least one memory storing instructions that, when executed by the at least one processor, cause the apparatus at least to:
establish an avatar call with a user device,
establish a data channel for avatar metadata exchange with the user device,
receive over the data channel a configuration message that indicates an animation fallback comprising a list of uniform resource names indicating supported animation data to be used as a fallback for animating an avatar when a selected animation stream stops,
receive over the data channel a stopped message indicating that the selected animation stream has become temporarily unavailable, the stopped message comprising a type field set to a uniform resource name that identifies the stopped message, and
use the animation fallback to animate the avatar in response to receiving the stopped message.

13. The apparatus of claim 12, wherein the stopped message further comprises a media identifier value of an audio stream used as the fallback when the selected animation stream stops.

14. The apparatus of claim 12, wherein the stopped message further comprises a reason field indicating a cause of disruption in the selected animation stream, the reason field comprising one of: device error, low-confidence for sensor data, or network issues.

15. The apparatus of claim 12, wherein the at least one memory stores instructions that, when executed by the at least one processor, cause the apparatus at least to:
receive over the data channel a resumed message indicating that the selected animation stream has become available again, the resumed message comprising a type field set to a uniform resource name that identifies the resumed message, and
resume using the selected animation stream to animate the avatar in response to receiving the resumed message.

16. The apparatus of claim 12, wherein the at least one memory stores instructions that, when executed by the at least one processor, cause the apparatus at least to:
send over the data channel a response message that indicates a selected animation fallback from the list of uniform resource names.

17. An apparatus comprising:
at least one processor, and
at least one memory storing instructions that, when executed by the at least one processor, cause the apparatus at least to:
establish an avatar call with a user device,
establish a data channel for avatar metadata exchange with the user device,
receive over the data channel a configuration message that indicates an animation fallback comprising a list of uniform resource names indicating supported animation data to be used as a fallback for animating an avatar when a selected animation stream stops,
detect that the selected animation stream has stopped by detecting an absence of animation data, and
use voice data to animate the avatar based on the animation fallback in response to detecting that the selected animation stream has stopped.

18. The apparatus of claim 17, wherein the at least one memory stores instructions that, when executed by the at least one processor, cause the apparatus at least to:
receive over the data channel a resumed message indicating that the selected animation stream has become available again, the resumed message comprising a type field set to a uniform resource name that identifies the resumed message, and
resume using the selected animation stream to animate the avatar in response to receiving the resumed message.

19. The apparatus of claim 17, wherein the animation fallback comprises an audio stream uniform resource name, and wherein the voice data is from a real-time transport protocol stream identified by a media identifier value.

20. The apparatus of claim 17, wherein the at least one memory stores instructions that, when executed by the at least one processor, cause the apparatus at least to:
send over the data channel a response message that indicates a selected animation fallback from the list of uniform resource names.
